(19) United States
(12) Patent Application Publication
(10) Pub. No.: US 2007/0189768 A1
(43) Pub. Date: Aug. 16, 2007

(54) Optical network unit and control method thereof

(75) Inventors: Heng-Yi Yang, Taoyuan Hsien (TW); Chiang-Pu Huang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/657,031

(22) Filed: Jan. 24, 2007

(30) Foreign Application Priority Data
Feb. 10, 2006 (TW) 095104552

(51) Int. Cl. H04B 10/08

(52) U.S. Cl. 398/38

(57) ABSTRACT

An optical network unit (ONU) includes an optical receiving module, an energy transforming module and an adjusting module. The optical receiving module receives an optical power signal. The energy transforming module transforms the optical power signal into a level signal. The adjusting module generates a power adjusting signal in accordance with the level signal. A transmitting power of the ONU is adjusted in accordance with the power adjusting signal. A control method of an optical network unit is also disclosed, which includes the steps of: receiving an optical power signal, transforming the optical power signal into a level signal, generating a power adjusting signal in accordance with the level signal, and adjusting a transmitting power of the ONU in accordance with the power adjusting signal.

This Non-provisional application claims priority under 35 U.S.C. §119(a) on Patent Application No. 095104552 filed in Taiwan, Republic of China on Feb. 10, 2006, the entire contents of which are hereby incorporated by reference.

### BACKGROUND OF THE INVENTION

1. Field of Invention

The invention relates to an optical network unit and, in particular, to an optical network unit which can actively control the transmitting power.

2. Related Art

Referring to FIG. 1, a passive optical network (PON) 1 is a technique of transmitting information from one point to multiple other points through a fiber. In general, the passive optical network 1 includes an optical line terminal (OLT) 11, a plurality of optical network units (ONU) 12 and an optical distribution network (ODN) 13. The information is transmitted between the optical line terminal 11 and the plurality of optical network units 12 through the optical distribution network 13. The optical distribution network 13 is composed of a plurality of optical splitters 131.

A receiving unit of the optical line terminal 11 has to possess high sensitivity and wide dynamic range since the operation speed of the receiving unit must be faster than 1244.16 Mb/s. The optical network unit 12 has a transmitter for transmitting information to the optical line terminal 11 through the optical distribution network 13. If the transmitting power of the transmitter is too high, the load of a receiving unit of the optical line terminal 11 will be too heavy. In contrary, if the transmitting power is insufficient, the optical line terminal 11 will determine the information as noise signal so that the information will be lost. Therefore, the transmitting power between the optical line terminal 11 and the optical network unit 12 must be suitable for maintaining the lifetime of the optical line terminal 11 and avoiding information loss.

The distance between each optical network unit 12 and the optical line terminal 11 is different because the optical network units 12 are located at different places. The conventional transmitting power determination method of the optical network unit 12 includes the steps of: delivering a test signal to each optical network unit 12 from the optical line terminal 11; delivering an optical power signal to the optical line terminal 11 from each optical network unit 12; measuring an intensity of the optical power signal transmitted from each optical network unit 12 by the optical line terminal 11; and then notifying each optical network unit 12 whether to increase or decrease the transmitting power or to maintain the current transmitting power depended on the measured intensity. In other words, the transmitting power of the optical network unit 12 can only be increased or decreased passively and possess no internal active self-control. Thus, the optical line terminal 11 must equip with powerful calculation ability to maintain the transmission efficiency of the passive optical network 1. As a result, the optical line terminal 11 usually has a complex design.

Therefore, it is a subject to provide an optical network unit and a control method thereof, which can simplify the complex design of the optical line terminal of the passive optical network, with the function of actively controlling or determining the needed transmitting power.

### SUMMARY OF THE INVENTION

In view of the foregoing, the invention is to provide an optical network unit and a control method thereof, which can actively control the transmitting power so as to simplify the design of the optical line terminal in a passive optical network and to maintain the optimal information transmission.

To achieve the above, an optical network unit (ONU) includes an optical receiving module, an energy transforming module and an adjusting module. The optical receiving module receives an optical power signal. The energy transforming module transforms the optical power signal into a level signal. The adjusting module generates a power adjusting signal in accordance with the level signal. The transmitting power of the optical network unit is adjusted in accordance with the power adjusting signal.

Additionally, to achieve the above, a control method of the optical network unit includes the steps of: receiving an optical power signal; transforming the optical power signal into a level signal, generating a power adjusting signal in accordance with the level signal; and adjusting a transmitting power of the optical network unit in accordance with the power adjusting signal.

As mentioned above, the optical network unit and the control method thereof have the energy transforming module and the adjusting module, so that the optical network unit can actively determine and control the level of the needed transmitting power in accordance with the optical power signal transmitted from the optical line terminal. Compared to the conventional art, the optical network unit of the invention, applied within a passive optical network, can simplify the design of the optical line terminal. In addition, the optical network unit can dynamically alter the transmitting power at any time so as to optimize the efficiency of the information transmission.

### BRIEF DESCRIPTION OF THE DRAWINGS

The invention will become more fully understood from the detailed description given herein below illustration only, and thus is not limitative of the present invention, and wherein:

FIG. 1 is a configuration diagram showing a conventional passive optical network;

FIG. 2 is a block diagram showing an optical network unit according to an embodiment of the invention;

FIG. 3 is a schematic diagram showing an adjusting module of the optical network unit in FIG. 2;

FIG. 4 is a main circuitry showing a power adjusting circuit of the adjusting module in FIG. 3;

FIG. 5 is a schematic diagram showing a relation between a level signal generated by an energy transforming module and a power adjusting signal generated by the adjusting module of the optical network unit according to the embodiment of the invention; and

FIG. 6 is a flow chart showing a control method of the optical network unit according to the embodiment of the invention.

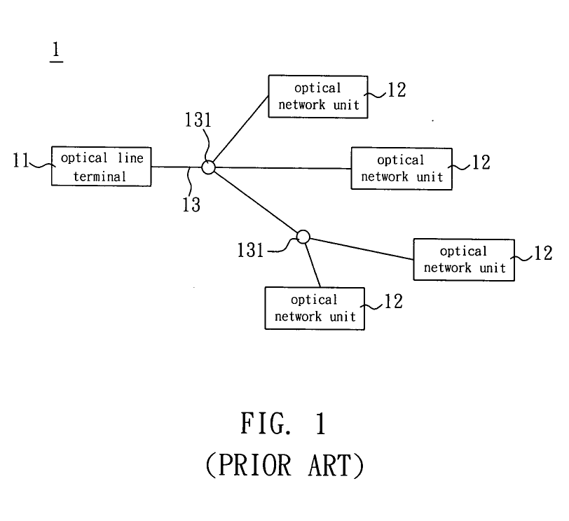

### DETAILED DESCRIPTION OF THE INVENTION

The present invention will be apparent from the following detailed description, which proceeds with reference to the accompanying drawings, wherein the same references relate to the same elements.

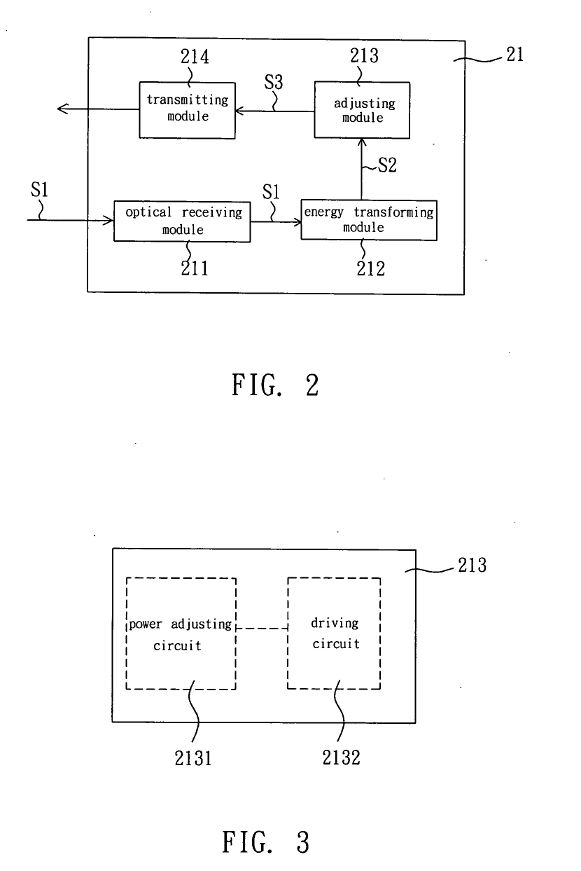

Referring to FIG. 2, an optical network unit 21 according to an embodiment of the invention can be applied in a passive optical network with an optical line terminal. The optical network unit 21 includes an optical receiving module 211, an energy transforming module 212 and an adjusting module 213.

The optical receiving module 211 receives an optical power signal S1, which is transmitted to the optical receiving module 211 of the optical network unit 21 from the optical line terminal through an optical distribution network (not shown).

The energy transforming module 212 transfers the optical power signal S1 to a corresponding level signal S2. In the embodiment, the level signal S2 is a voltage signal.

The adjusting module 213 generates a power adjusting signal S3 in accordance with the level signal S2 and adjusts the transmitting power of a transmitting module 214 of the optical network unit 21 in accordance with the power adjusting signal S3. In the embodiment, power adjusting signal S3 is a current signal and the transmitting module 214 is a laser module.

Referring to FIG. 3, the adjusting module 213 includes a power adjusting circuit 2131 and a driving circuit 2132. In the embodiment, the power adjusting circuit 2131 receives the level signal S2 and generates the power adjusting signal S3. The driving circuit 2132 drives the transmitting power of the transmitting module 214 of the optical network unit 21 in accordance with the power adjusting signal S3. In the embodiment, the driving circuit 2132 can be implemented by a digital technique such as a driving integrated circuit (IC).

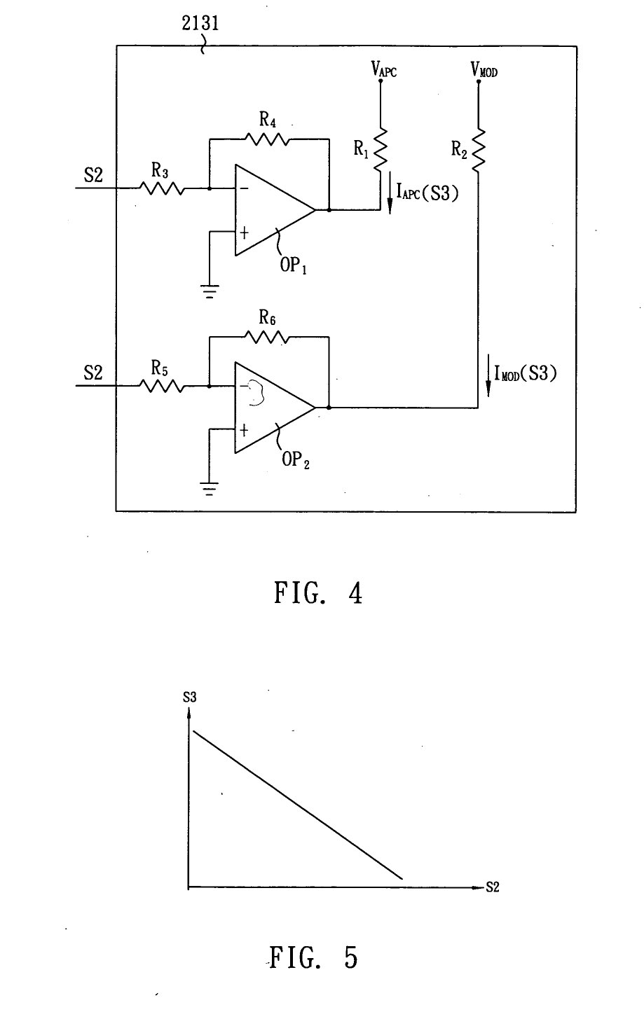

In general, the driving circuit 2132 of the transmitting module 214 is a voltage control current source (VCCS), which is controlled by a bias current and a modulating current. Referring to FIG. 4, in the embodiment, the power adjusting circuit 2131 includes two set of operational amplifiers OP1 and OP2 to respectively generate the adjusting signal S3 in accordance with the level signal S2. The power adjusting signal S3 is the bias current IAPC and modulating current IMOD shown in FIG. 4. In the embodiment, a negative feedback operational amplifier consists of the operational amplifier OP1 and two resistors R3 and R4, and another negative feedback operational amplifier consists of the operational amplifier OP2 and two resistors R5 and R6. The formulas are as follows:

$${V}_{APC} = {R}_{1} {I}_{APC} - \frac{{R}_{4} {S}_{3}}{{R}_{3}}$$

$${V}_{MOD} = {R}_{2} {I}_{MOD} = \frac{{R}_{6} {S}_{3}}{{R}_{5}}$$

Wherein, R1 represents the bias resistance, R2 represents the modulating resistance, V_{APC} represents the bias voltage and V_{MOD} represents the modulating voltage. In the embodiment, a bias resistance R1 processes the power adjusting signal S3 to generate the level signal S2, and the modulation resistance R2 processes the power adjusting signal S3 to generate the level signal S2.

As mentioned in the formulas, and referring to FIG. 5, the relation between the level signal S2 and the power adjusting signal S3 is linear and the level signal S2 and the power adjusting signal S3 have an inverse ratio. In other words, the optical power signal S1 received by the optical receiving module 211 of the optical network unit 21 is greater when the optical network unit 12 is nearer to the optical line terminal 11. Thus, the transmitting module 214 of the optical network unit 21 uses a relatively small transmitting power to transmit the information from the optical network unit 21 to the optical line terminal 11.

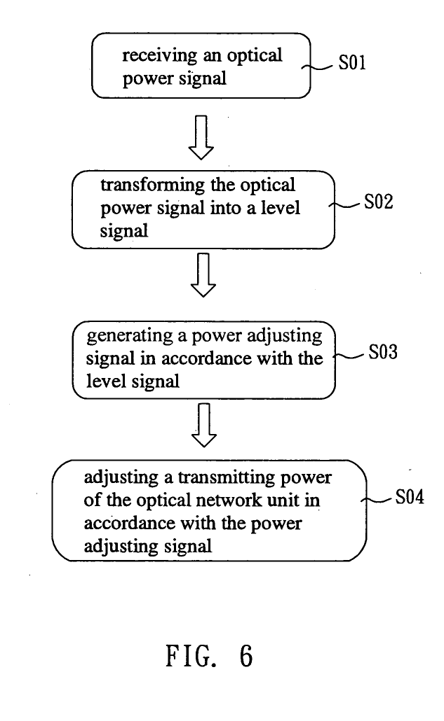

Referring to FIG. 6, a control method of an optical network unit includes the following steps of: receiving an optical power signal (step S01), transforming the optical power signal into a level signal (step S02), generating a power adjusting signal in accordance with the level signal (step S03), and adjusting a transmitting power of the optical network unit in accordance with the power adjusting signal (step S04).

The control method of the optical network unit is illustrated in the above embodiment, so the detailed descriptions are omitted for conciseness.

In summary, the optical network unit and the control method thereof have the energy transforming module and the adjusting module, so that the optical network unit can actively determine and control the level of the needed transmitting power in accordance with the optical power signal transmitted from the optical line terminal. Compared to the conventional art, the optical network unit of the invention, applied within a passive optical network, can simplify the design of the optical line terminal. In addition, the optical network unit can dynamically alter the transmitting power at any time so as to optimize the efficiency of the information transmission.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An optical network unit, comprising:
an optical receiving module receiving an optical power signal;
an energy transforming module transforming the optical power signal into a level signal; and
an adjusting module generating a power adjusting signal to adjust a transmitting power of the optical network unit in accordance with the power adjusting signal.

2. The optical network unit according to claim 1, wherein the level signal is a voltage signal.

3. The optical network unit according to claim 1, wherein the adjusting module comprises:
a power adjusting circuit receiving the level signal and generating the power adjusting signal; and
a driving circuit adjusting the transmitting power of the optical network unit in accordance with the power adjusting signal.

4. The optical network unit according to claim 3, wherein the power adjusting circuit comprises an operational amplifier, a negative feedback operational amplifier, a bias resistor, or a modulation resistor.

5. The optical network unit according to claim 1, wherein the power adjusting signal is a current signal.

6. The optical network unit according to claim 1, wherein the level signal has a linear relation with the power adjusting signal.

7. The optical network unit according to claim 1, wherein the level signal is inversely proportional to the power adjusting signal.

8. The optical network unit according to claim 1, wherein the power adjusting module adjusts the transmitting power of a transmitting module of the optical network unit in accordance with the power adjusting signal.

9. The optical network unit according to claim 1, wherein the transmitting module is a laser module.

10. The optical network unit according to claim 1, wherein the optical network unit is applied in a passive optical network.

11. The optical network unit according to claim 3, wherein the driving circuit is a driving IC.

12. A control method of an optical network unit, comprising the steps of:
receiving an optical power signal;
transforming the optical power signal into a level signal;
generating a power adjusting signal in accordance with the level signal; and
adjusting a transmitting power of the optical network unit in accordance with the power adjusting signal.

13. The control method according to claim 12, wherein the bigger the level signal the smaller the power adjusting signal.

14. The control method according to claim 13, wherein the power adjusting signal is processes by a bias resistor to generate the level signal.

15. The control method according to claim 13, wherein a modulation resistor processes the power adjusting signal to generate the level signal through.

16. The control method according to claim 12, wherein the level signal is a voltage signal.

17. The control method according to claim 12, wherein the power adjusting signal is a current signal.

18. The control method according to claim 12, wherein the power adjusting signal is used to adjust the transmitting power of a transmitting module of the optical network unit.

19. The control method according to claim 18, wherein the transmitting module is a laser module.
